(19) United States
(12) Patent Application Publication
(10) Pub. No.: US 2025/0074103 A1
(43) Pub. Date: Mar. 6, 2025

(54) Method for Manufacturing Personalized Decorative Laminated Panels, and Personalized Decorative Laminated Panels

(71) Applicant: I4F Licensing NV, Turnhout (BE)

(72) Inventor: Eddy Alberic Boucké, Turnhout (BE)

(21) Appl. No.: 18/724,649

(22) PCT Filed: Dec. 28, 2022
(86) PCT No.: PCT/EP2022/087960

§ 371 Date: Jun. 27, 2024

(30) Foreign Application Priority Data
Dec. 28, 2021 (NL) 2030319

(51) Int. Cl. B44C 5/04; B41M 3/00; B41M 5/00; E04F 15/02; G06Q 30/0601

(52) U.S. Cl. CPC B44C 5/04; B41M 3/008; B41M 5/0047; E04F 15/02038; G06Q 30/0621; E04F 2201/023

(57) ABSTRACT

A method for manufacturing personalized or customized decorative laminated panels, in particular decorative floor panels, wall panels, or ceiling panels, for composing a decorative surface covering, in particular a decorative floor covering, wall covering, or ceiling covering. A computer system and a non-transitory computing device-readable medium having executable instructions to cause one or more processors to perform the method according to the invention. A personalized or customized decorative laminated panel, in particular a decorative floor panel, a wall panel, or a ceiling panel, for composing a decorative surface covering, in particular a decorative floor covering, a wall covering, or a ceiling covering in particular obtained by applying the method according to the invention.

### CROSS-REFERENCE TO RELATED APPLICATIONS

This application is the United States national phase of International Patent Application No. PCT/EP2022/087960, filed Dec. 28, 2022, and claims priority to The Netherlands Patent Application No. 2030319, filed Dec. 28, 2021, the disclosures of which are hereby incorporated by reference in their entireties.

### BACKGROUND OF THE INVENTION

### Field of the Invention

The invention relates to a method for manufacturing personalized or customized decorative laminated panels, in particular decorative floor panels, wall panels, or ceiling panels, for composing a decorative surface covering, in particular a decorative floor covering, wall covering, or ceiling covering. The invention also relates to a computer system and a non-transitory computing device-readable medium having executable instructions to cause one or more processors to perform the method according to the invention. The invention further relates to a personalized or customized decorative laminated panel, in particular a decorative floor panel, a wall panel, or a ceiling panel, for composing a decorative surface covering, in particular a decorative floor covering, a wall covering, or a ceiling covering in particular obtained by applying the method according to the invention.

Description of Related Art

Laminated panels comprise a decorative layer having a decorative pattern which typically has the appearance of a wood pattern. The decorative layer may be digitally printed, and is typically covered by a transparent layer to preserve and protect the decorative layer. In order to improve the optical and haptical appearance of the decorative pattern of the decorative layer, impressions can be realized in the transparent layer, this in order to obtain an e.g., imitation of wood pores and other unevennesses which can be present at the surface of real wood. The impressions may be applied in register with the wood pattern lying underneath said impression, which is also referred to as embossing in register. Since consumers are more and more demanding, decorative panel manufacturers keep improving and changing their panel gamma to satisfy the consumer's needs.

### SUMMARY OF THE INVENTION

It is a first object of the invention to provide an improved method for manufacturing panels to satisfy the aforementioned need of the consumer.

It is a second object of the invention to provide a more flexible method for manufacturing panels, in particular to expand a floor manufacturers panel gamma.

At least one of these objects can be achieved by providing a method according to the preamble, comprising the steps of:
A) allowing a user to select and/or design at least one digital image relating to the decorative laminated panels to be manufactured,
B) allowing a user to select and/or design at least one digital embossing structure relating to the decorative laminated panels to be manufactured,
C) based upon the user selection made during step A) digitally printing by a printing device the at least one selected digital image onto a substrate, and
D) based upon the user selection made during step B) applying, preferably at least partially by means of digital printing by a printing device, the at least one selected embossing structure, directly or indirectly, on top of said printed digital panel image, such that the digital panel image is at least partially visible through said embossing structure, thereby forming either a laminated decorative panel or a decorative laminate to be divided into decorative laminated panels.

The method according to the invention has the major advantage that not only the decorative image is selected, and preferably designed, by a user, but also that the embossing structure (embossing pattern) is selected, and preferably designed by said user, preferably at least partially independently of the selected decorative image. This leads to a fully customized, and preferably personalized, look and feel appearance of the decorative laminated panels as such, and hence of the decorative surface covering as such. In this manner, the freedom of design of the decorative laminated panels is increased significantly and, the created two levels of freedom of design (the decorative image and the embossing structure) may lead to an infinite number of possible combinations of images and embossing structure, which meets the consumer's needs in this respect, contrary to known solution where the embossing structure is entirely predefined based upon the decorative image and not user-definable. Moreover, since in step C) and D) use of made of digital printing, this manufacturing process leads to high flexibility and the possibility to produce small print runs and to reduce the waste of consumables.

The digital image can, for example, be a photograph, or other image such as a drawing, painting, etc., that the user wants placed on its surface covering, in particular its flooring. Often, the digital image is digitized, formatted, and enhanced digital image with dimensions that will cover either an individual laminated panel desired or the entire surface covering desired. In this latter case, the digital image is segmented into individual sections, each of which is sized to be placed on a single panel. The individual sections are then arranged to allow for the spaces described above that are required for machining. The formatted digital image, including each of the individual segments, is then printed on a substrate and used as the design surface in the laminated panel, after which the substrate is preferably divided (according to step E) of the method according to the invention), e.g. by sawing or milling, into a plurality of laminated panels. Often, in case a selected image covers a plurality of the laminated panels, a digital layout is created of the panels (to be manufactured), which can be a staggered layout or a non-staggered layout. Preferably, the method further comprises step F), performed after step B), which comprises the step of creating a, preferably non-staggered, digital layout of the embossing structure of the decorative laminate to be formed during step D), and wherein step E) is performed in register (in line) with the digital layout. A staggered layout may not be necessary for decorative wall panels, but for flooring panels such a layout is advantageous for obtaining a sturdy floor. A non-staggered digital layout allows the decorative laminated panels to be cut according to straight lines, such as the vertical lines and the horizontal lines rather than by zig-zag cutting.

The embossing structure defines an upper surface of the laminated panels, and typically enhances the look and feel of the laminated panels. The embossing structure typically comprises embossed zones (zones with one or more indentations) and non-embossed zones (zones with a plane surface). Examples of embossed applicable indentations in the one or more embossed zones are e.g. one or more grout lines, one or more bevels, a wood nerve pattern, a customized texture, a personalized texture. In the personalized texture, the texture may include one or more images, one or more characters, one or more letters, in particular one or more words, one or more symbols, etcetera. Typically, the embossing structure comprises a center portion which defines the structure (texture) of a major upper surface (front surface) of the panel, and a peripheral portion surrounding said center portion, which defines the structure (texture) of the edges of the panels. Typically, the peripheral portion is provided with at least one user selected, preferably user designed, bevel or grout line, which leads to a practically seamlessly look in between adjacent panels. In cross-sectional view, a bevel typically defines a downwardly inclined (flat) surface towards to panel edge, wherein a grout line, may have a step-like shape, a symmetric or asymmetric U-shapes, etc. The grout line may have one or more flat surfaces and/or rounded (curved) surfaces. One or more grout lines may also be positioned in the center portion of the embossing structure to virtually divide a panel into a plurality of smaller panels. It is imaginable that during step B) the user is allowed to choose the position of indentations relative to the panel (to be manufactured) and/or that the user is allowed to choose the depth of the indentations. Hence, in this way embossing structure of the panel can be fully customized, in particular personalized, to the user's own taste.

It is imaginable that step A) and step B) are completely unrelated to each other, wherein a user has the freedom to select the embossing structure entirely independent from the image selection. However, it is also imaginable that step B) is dependent on step A), wherein dependent on the image chosen during step A) limits, at least partially, the user's freedom to select an embossing of choice. In other words, the image selected during step A) may narrow down the selection of embossing structure variations the user is allowed to choose from during step B). It is further imaginable that dependent on the image chosen during step A), the user is provided during step B) with one or more suggested embossing structures to choose from and/or which can be taken as starting point for further customization and/or personalization and/or which can be ignored by the user. The one or more suggested embossing structures may be prestored embossing structures and/or may be calculated based upon the image(s) selected during step A). This embodiment can e.g. be favourable in case an embossing in register texture would be desired, wherein the texture of at least a part of the embossing structure is aligned with the image positioned underneath said embossing structure.

Preferably, the method is a computer-implemented method. Preferably, step A) and/or step B) is/are performed by a user using a digital user interface of a, preferably portable, user computing device. Typical examples of such a user computing device are a mobile phone, in particular a smartphone or feature phone, a tablet, a laptop, a desktop computer, and a smartwatch or any other smart wearable device. To this end feature phones should be understood as a type or class of (mobile) phones that are visually and dimensionally similar to early generations of mobile phones. The feature phones typically comprise press-buttons based inputs, such as a menu button and an “ok”, and “back” button, and a small, typically non-touch display. The display may typically be a colour display. Moreover, the feature phones typically use an embedded operating system. A smartphone should be understood as a type or class of (mobile) phones that performs many functions of a computer, typically provided with a touchscreen interface, internet access, and an extensive mobile operating system that allows for running, and downloading applications, multimedia functionality, alongside the core phone functions such as voice calls and text messaging. The user interface may form part of a native application installed and running on the user computing device, but may also be accessible via a web browser running on the user computing device. The user interface actually forms a (web) portal for the user to digitally customize, in particular personalize, the panel and surface covering to be manufactured. Typically, the user interface makes part of a web shop ran by a manufacturer or group of manufacturers.

Preferably, said user computing device is configured to communicate, preferably wirelessly, directly or indirectly, with at least one host computing device, such as a server, which is configured to control one or more printing devices used during steps C) and D). Typically, during step A) the selected and/or designed at least one digital image is, directly or indirectly, transmitted by said user computing device to said host computing device, wherein said host computing device is configured to, directly or indirectly, control a digital printing device for performing step C). Preferably, during step B) the selected and/or designed at least one digital embossing structure is, directly or indirectly, transmitted by said user computing device to said host computing device, wherein said host computing device is configured to, directly or indirectly, control a digital printing device for performing step D). The communication between the user computing device and host computing device preferably takes place by using the world wide web. Preferably, the host computing devices translates the user selection made during step A) and B) into one or more corresponding print jobs sent to the one or more printing devices. Preferably, the (digital) printing device used during step C) is a different (digital) printing device than the printing device used during step D). However, it is also imaginable that the (digital) printing device used during step C) is the same (digital) printing device as used during step D).

Steps A) and B) may at least partially overlap in time. Preferably, during step A) the user is provided with a collection of digital panel images, in particular digital motifs, preferably via a digital user interface, wherein the user selects at least one digital image of said collection. Additionally or alternatively, during step A) the user is preferably allowed to select, and more preferably upload, at least one personal digital panel image via a digital user interface. As already indicated above, during step B) the user is preferably allowed the select the design of at least one bevel and/or grout line, preferably to be located at at least one edge of the panel, wherein the at least one bevel and/or grout line makes part of the embossing structure.

During step D), preferably at least a part of the embossing structure is realized by means of mechanical processing, for example by either milling or cutting away panel and/or by means of position-selective deforming, in particular impressing, panel material. It is additionally or alternatively also imaginable that during step D) at least a part of the embossing structure is realized by multi-stage digital printing. This multi-stage digital printing process preferably comprises the sub-steps:
D1) applying a curable liquid base layer, such as a base ink layer and/or a lacquer layer, directly or indirectly, onto the printed decorative image, which preferably covers the entire printed decorative image,
D2) position-selectively applying, preferably printing, a liquid embossing ink onto the liquid base ink layer,
D3) polymerizing the base ink, and preferably the embossing ink, and
D4) preferably removing at least a part of the polymerized embossing ink, more preferably by means of mechanical processing, such as brushing.

The position-selectively applied, preferably printed, a liquid embossing ink typically acts as mask which prevents and/or inhibits polymerization of the base material of the base layer upon irradiation, in particular upon irradiation by means of UV light, which facilitates subsequent removal of the embossing ink together with an at least partially unhardened portion of the base material (located underneath said embossing ink and/or mixed with said embossing ink). In this manner a high-resolution texture can be created. This process is considered as a negative embossing process, since a base level of a base (ink) layer is position-selectively lowered and/or removed. Alternatively or additionally, the liquid embossing ink is position-selectively printed, directly or indirectly, onto the substrate to create the embossing structure from bottom to top (instead of vice versa), which is considered a positive embossing process. The cured (polymerized) ink of the embossing structure is at least partially transparent and/or translucent.

Typically, the liquid base layer, in particular the base ink layer and/or lacquer layer, can be of various chemical nature. Examples of suitable base materials for the base layer comprise at least one of the following materials: polyurethane, epoxy, acrylate, methacrylate, and/or acrylic resin. In a preferred embodiment the embossing ink is immiscible or partially miscible in the base material and, once polymerized, is mechanically removed from the base material. Thereby the main function of embossing ink is to create a three-dimensional structure without altering the chemical-physical properties of the base material. The polymerized embossing ink is more brittle and/or more liquid than the polymerized base material and thereby can be mechanically removed, together with an uncured part or partially cured part of the base material, from the (cured part of the) base material without damaging it. Consequently, if the base material will mainly be of apolar nature, the embossing ink will preferably be polar and vice versa. In a preferred embodiment of the invention the embossing ink comprises at least one photo-crosslinking resin. To be applied by digital printing, such as inkjet-printing, the embossing ink preferably has a viscosity of 10-15 cps at the operational printing temperature of typically 40-50° C. Consequently, similarly to other formulations (varnishes and inks) photo-crosslinkable by inkjet printing, the embossing ink will be mainly formed by (meth)acrylate and/or vinyl monomers. On the other hand, in order to control the rheology and reach the desired degree of hardness, in addition to the monomers, the embossing ink could also contain acrylate oligomers. In order to obtain a brittle and easily removable formulation, ingredients characterized by a low glass transition temperature can be used, such as isodecyl-acrylate, 2-(2-ethoxyethoxy) ethyl acrylate, octyl-decyl-acrylate, tri-decyl-acrylate, laurylacrylate, diacrylate polyethylene glycols of various molecular weight. In a further preferred embodiment of the invention, the embossing ink has sufficiently high surface tension, with respect to the base material, so as to penetrate into the base material while maintaining the shape and thereby creating detailed structures. If on the contrary the surface tension of the embossing ink were too low with respect to that of the base material, there would be a loss of definition, having as a result the fact that the embossing ink will wet the surface of the base material. In a preferred embodiment of the invention, the embossing ink is able to quickly penetrate and effectively mix with the base material. In another further preferred embodiment of the invention, the embossing ink is able to quickly penetrate and not mix or partially mix with the base material. In a preferred embodiment of the method according to the invention, the embossing ink comprises at least one substance configured to inhibit the polymerization of the base material. After the polymerization, the areas printed with the embossing ink will typically be more brittle than the base material. For example, if the base material is constituted by photo-crosslinking resins, the embossing ink can contain polymerization inhibitors such as UV absorbers for example 2-hydroxyphenyl-benzophenones (BP), 2-(2-hydroxyphenyl)-benzotriazoles (BTZ) and 2-hydroxyphenyl-s-triazines (HPT); stereo-hindered amines (HALS) for example 2,2,6,6-tetramethyl piperidines (TMP); antioxidants (AO) for example sterically hindered phenols, secondary thioethers, phosphites, stabilizers (in-can stabilizer) for example quinone methide, radical scavengers. In a further embodiment of the invention, the embossing ink once polymerized has a glass transition temperature lower than the base material and, consequently, the areas printed with the embossing ink will be easier to be removed than the polymerized base material. In some embodiments, the embossing ink contains additives which serve to modify properties such as the rheology and/or printability and/or colour and can comprise photo-initiators, levelling agents, oils, light stabilizers, antioxidants, biocides, pigments, rheology modifiers, humectants, defoamers and mixtures thereof. Preferably, the embossing ink has a surface tension higher than the base material. Similarly to the base material, the surface tension of the embossing ink can be modulated both by selecting raw materials and by using additives, the same described above to modify the base material. In addition to modifying the surface tension to obtain more or less marked penetration effects, the addition of surface tension modifiers contributes to improve the printability of the embossing ink, especially when using inkjet printers. The control of the depth of the embossing ink in the base material can be modulated in different ways, such as for example by applying more or less embossing ink, and/or by applying more or less base material (leading to a thicker or thinner base layer), and/or by making more or less time passing between the application of the embossing ink and the subsequent polymerization of the base material and embossing ink, and/or by varying the speed of the droplet of the embossing ink by using the waveform, where the quicker droplets will be able—due to their higher impact—to penetrate deeper into the base material.

Preferably, the method comprises step G), performed after step D), which comprises applying a top coating on top of the embossing structure. The top coating preferably comprises aluminium oxide used in the present invention is also known as alumina or Al2O3. Preferably, the aluminium oxide is fused or calcined. The fused or calcined aluminium oxide preferably has a desired hardness of from about 6 to about 9 on a Moh's scale, and most preferably about 9 on a Moh's scale. Preferably, the particle size of the aluminium oxide is from about 10 microns to about to about 70 microns, and more preferably from about 20 microns to about 50 microns. The presence of alumina provides improved wear and/or stain resistance to the surface covering.

The method preferably comprises step H), performed after steps A) and B) and prior to step C), which comprises presenting a digital preview of the decorative panel to be manufactured. This digital preview can be presented on the user computing device and allows the user to see the panels before manufacturing.

The method preferably comprises step I), preferably performed after step D), which comprises profiling at least two opposing edges of the decorative panel, such that at least one pair of opposing panel edges is provided with complementary coupling profiles allowing adjacent decorative panels to be interconnected. Optionally, the user is allow to choose whether or not coupling profiles should be created during step I), and if so, which edges to be provided with coupling profiles. It is imaginable that panel is free of any coupling profiles, which is typically the case in case the panels are glued onto a subfloor. It is also imaginable that during step I) the panel is provided with two coupling profiles or with four coupling profiles, or with an alternative number of coupling profiles. For wall panels, the panel is typically provided with two coupling profiles, while for floor panels, the panel is typically provided with four coupling profiles. The panels to be created by applying the method according to the invention may have a triangular shape, a square shape, an oblong rectangular shape, a hexagonal shape, or any other suitable shape.

Preferably, during step I) a first panel edge is provided with a first coupling profile, and a second panel edge is provided with a complementary second coupling profile being designed to, either directly or indirectly, interlock adjacent panels. In case of direct interlocking, which is typically preferred, a coupling profile of a panel will directly co-act with a complementary coupling profile of an adjacent panel. In case of indirect interlocking, typically a separate coupling structure (connecting element) is used to mutually couple of plurality of panels, wherein a coupling profile of each of said panel is coupled to the coupling structure. In coupled condition, the floor panels may abut each other, or, alternatively, may be positioned at a distance from each other. During step I) a third panel edge may be provided with a third coupling profile, and a fourth panel edge may be provided with a complementary fourth coupling profile being designed to, either directly or indirectly, interlock adjacent panels. In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank.

Preferably, the method comprises step J), which comprises the step of creating a user profile relating to the user, and wherein the user selection made during steps A) and B) is digitally stored within said user profile. This facilitates providing service to the user relating to a user's order for a customized and/or personalized surface covering, and moreover facilitates placing a new order for the user. It could be preferred that the user interface allows payment information to be entered and even that user payment information is stored in the user profile. This allows the user to place paid decorative surface covering orders via the user interface.

The substrate may be a thin flexible layer or may be thicker, more rigid layer. In a preferred embodiment, the substate comprises a paper layer or polymer foil. Prior to performing steps C) and D) or after having performed steps C) and D), preferably method step K) is applied, comprising the step of adhering the substrate, directly or indirectly, to a core of the panel, preferably by means of gluing and/or heat-pressing. It is also imaginable that the substrate comprises a core, and preferably a primer layer applied on top of said core. Preferably, the core has a thickness of between 2 and 14 mm. The core may be flexible, semi-flexible, or rigid. The core may be foamed or unfoamed. The core may be composed of a homogenous material, such as a composite. However, the core may also be composed of a plurality of sub-layers which may include one or more reinforcement layers.

Preferably, the base material of the core comprises a (main) polymer, preferably a thermoplastic material, which is more preferably chosen from the group consisting of: PVC, PET, PP, PS, thermoplastic polyurethane (TPU), PE, in particular MDPE and/or HDPE; and combinations thereof. PS may be in the form of expanded PS (EPS) in order to further reduce the density of the floor covering element, which leads to a saving of costs and facilitates handling of the panels. Also in case another thermoplastic material is used, this material may be applied in foamed state in the core to reduce the density and costs. Nevertheless, it is also imaginable that the thermoplastic material used as main polymer is a solid polymer (i.e. an unfoamed polymer). Preferably, at least a fraction of the polymer used may be formed by recycled thermoplastic, such a recycled PVC or recycled PU. It is conceivable that a mix of virgin and recycled thermoplastic material is used to compose at least a part of the core. Instead of the thermoplastic material, also a thermoset polymer may be used, such as thermoset polyurethane.

At least a part of the core may be made of a composite of at least one polymer and at least one non-polymeric material. The composite of the core layer preferably comprises one or more fillers, wherein at least one filler is preferably selected from the group consisting of: talc, chalk, wood, calcium carbonate, titanium dioxide, calcined clay, porcelain, glass, carbon particles, silicon particular, a(nother) mineral filler, a(nother) natural filler, a(nother) (auxiliary) polymer, such as an elastomer and/or latex. It is also imaginable that rubber and/or elastomeric parts (particles) are dispersed within the composite to improve the flexibility and/or impact resistance at least to some extent. The core may (thus) be rigid, semi-flexible, or flexible, and so can be the floor covering element as such. The filler may be formed by fibres, such as glass fibers or synthetic or genuine leather fibers, and/or may be formed by dust-like particles. Here, the expression “dust” is understood as small dust-like particles (powder), like bamboo dust, wood dust, cork dust, or non-wood dust, like mineral dust, stone powder, in particular cement, and combinations thereof. The average particle size of the dust is preferably between 14 and 20 micron, more preferably between 16 and 18 micron. The primary role of this kind of filler is to provide the core, and the panel as such, sufficient hardness and/or to decrease the cost price of the core, and hence of the panel. Moreover, this kind of filler will typically also improve the impact strength of the core and of the panel as such. Preferably, the filler content in the composite material of the core is between 30 and 75% by weight of the composite material of the core, more preferably between 50 and 60% by weight of the composite material of the core. Preferably, the polymer content in the composite material of the core is between 25 and 70% by weight of the composite material of the core, more preferably between 40 and 50% by weight of the composite material of the core. The polymer can either be foamed or unfoamed. Preferably, the composite of the core comprises at least one filler selected from the group consisting of: a salt, a stearate salt, calcium stearate, and zinc stearate. Stearates have the function of a stabilizer, and lead to a more beneficial processing temperature, and counteract decomposition of components of the composite during processing and after processing, which therefore provide long-term stability. Instead of or in addition to a stearate, for example calcium zinc may also be used as stabilizer. The weight content of the stabilizer(s) in the composite will preferably be between 1 and 5%, and more preferably between 1.5 and 4%. The composite of the core preferably comprises at least one impact modifier comprising at least one alkyl methacrylate, wherein said alkyl methacrylate is preferably chosen from the group consisting of: methyl methacrylate, ethyl methacrylate, propyl methacrylate, isopropyl methacrylate, t-butyl methacrylate and isobutyl methacrylate. The impact modifier typically improves the product performance, in particular the impact resistance. Moreover, the impact modifier typically toughens the core layer and can therefore also be seen as toughening agent, which further reduces the risk of breakage. Often, the modifier also facilitates the production process, for example, as already addressed above, in order to control the formation of the foam with a relatively consistent (constant) foam structure. The weight content of the impact modifier in the composite will preferably be between 1 and 9%, and more preferably between 3 and 6%. At least one plastic material used in the core layer is preferably free of any (toxic) plasticizer in order to increase the desired rigidity of the core layer, which is, moreover, also favourable from an environmental point of view. The core and/or another layer of the panel may comprise wood-based material, for example, MDF, HDF, wood dust, bamboo, prefabricated wood, more particularly so-called engineered wood. This wood-based material may be part of a composite material of the core.

Alternatively, the core is at least partially composed of another base material, such as a mineral material, like magnesium oxide, magnesium hydroxide, gypsum, (lightweight) concrete, and/or clay; and/or a wood or a wood-based material, such as HDF or MDF, or any other thermoplastic-free material, may be used as base material.

The density of the core typically varies from about 0.1 to 1.5 grams/cm³, preferably from about 0.2 to 1.4 grams/cm³, more preferably from about 0.3 to 1.3 grams/cm³, even more preferably from about 0.4 to 1.2 grams/cm³, even more preferably from about 0.5 to 1.2 grams/cm³, and most preferably from about 0.6 to 1.2 grams/cm³. It is imaginable that each panel comprises a plurality of core (sub)layers. Different core (sub)layers may have either identical compositions or different compositions, and/or different densities.

Preferably, a rear side of the panel is provided with a positioning code for positioning the decorative laminated panel at the correct location for composing the decorative surface covering. The use of a positioning code on the rear side of decorative laminated panels allows to efficiently assembly the decorative laminated panels so that the personalized or customized image is reproduced. Preferably, a rear side of the panel is provided with user details or an identification code for identifying the user and/or his delivery address. The identification code is preferably printed on the back-side of decorative laminated panel. Instead of an identification code also customer details, such as name and delivery address, may be applied on the back-side of decorative laminated panel as alphanumeric data. The advantage is that these details can immediately read this without any electronic tools.

Preferably, the method comprises step L) comprising the step of allowing a user to select at least one other decorative laminated panel related characteristic, and wherein the method further comprises step M) comprising the step of incorporating the at least one characteristic selected during step L) into the decorative laminated panel during manufacturing of said panel. Examples of the characteristics which can be chosen by a user during step L) are: the number of coupling profiles, the type of coupling profiles, a substrate material, the substrate thickness, the dimensioning (in particular the width and length) of the panel, the presence or absence of a backing layer to be adhered to a rear side of the substrate, the backing layer type, the acoustic properties (sound dampening properties) of at least one panel layer and/or of the panel as such, the density of the panel, the reflectivity and/or gloss of the upper surface of the panel, the colour of the embossing structure, the anti-slip properties of the panel as such, the presence of anti-slip particles in the panel, in particular the presence of anti-slip particles in the embossing structure, anti-electrostatic properties, etc. Based on preferred panel or layer properties, a flooring manufacturing will typically which material(s) has/have to be used.

The customized and/or personalized decorative laminated panel may be applied as floor panel, wall panel, ceiling panel, or alternative surface covering panel for composing a decorative surface covering, in particular a decorative floor covering, wall covering, ceiling covering, or alternative surface covering. The panels manufactured by applying the method according to be invention may be used indoor and outdoor.

Although it is commonly preferred to allow the user to choose both the decorative image of the panel (i.e. the ‘look’ of the panel) as well as the embossing structure of the panel (i.e. the ‘look and feel’ of the panel), it is imaginable that the method according to the invention includes steps B) and D), without including steps A) and C). It is further conceivable that the method includes steps A) and C) and steps L) and M), without including steps B) and D). Furthermore, it is imaginable that in the method according to the invention, steps A), B), C), and D) are entirely replaced by steps L) and M).

The invention additionally relates to a personalized or customized decorative laminated panel, in particular a decorative floor panel, for composing a decorative surface covering, in particular a decorative floor covering, in particular obtained by applying the method according to the invention, comprising: a substrate, a personalized or customized decorative image digitally printed on top of said substrate, and a personalized or customized embossing structure applied, and preferably digitally printed, on top of said decorative image. Further embodiments and advantages of the panel according to the invention have been described above and are described below in an extensive, non-limitative manner.

The invention also relates to a computer system, comprising at least one processor, at least one host computing device with at least one host processor, at least one user computing device with at least one user processor, and at least one computing device-readable medium having executable instructions to cause one or more of said processors to perform the method according to the invention.

Embodiments and advantages of the computer system according to the invention have been described above and are described below in an extensive, non-limitative manner.

The invention further relates to a, typically non-transitory, computing device-readable medium having executable instructions to cause one or more processors to perform the method according to the invention. Examples of such instructions-bearing media include a recordable type medium such as magnetic tape, floppy disk, a hard disk drive, Compact Disc (CD), a Digital Video Disk (DVD), Blu-Ray Disc, a digital tape, a computer memory, a DVD-ROM, a DVD-RAM, a DVD+RW, a DVD-RW, a DVD-R, a DVD+R, a CD-ROM, a CD-R, a CD+R, a CD+RW, a CD-RW, a Video Compact Discs, a Super Video Discs, a flash memory, a magnetic tape, a magneto-optic disk, a MINIDISC, a non-volatile memory card, an EEPROM, an optical disk, an optical storage, RAM, ROM, a system memory, a web server, a cloud, and the like.

In certain cases, the use of the system or method according the invention may occur in a territory even if components of the system are located and/or steps of the method are processed outside the territory.

### BRIEF DESCRIPTION OF THE DRAWINGS

The terms Fig., Figs., Figure, and Figures are used interchangeably in the specification to refer to the corresponding figures in the drawings.

The invention will be further elucidated according to the following non-limitative figures:

FIG. 1 shows a schematic simplified overview of a system for personalizing or customizing a panel according to the invention; and

FIGS. 2A and 2B show a bottom side and upper side of a simplified floor covering according to the present invention; and

FIG. 3 shows a part of the system for personalizing or customizing a panel according to the invention; and

FIG. 4 shows a perspective view of a laminated panel according to an embodiment of the invention.

### DESCRIPTION OF THE INVENTION

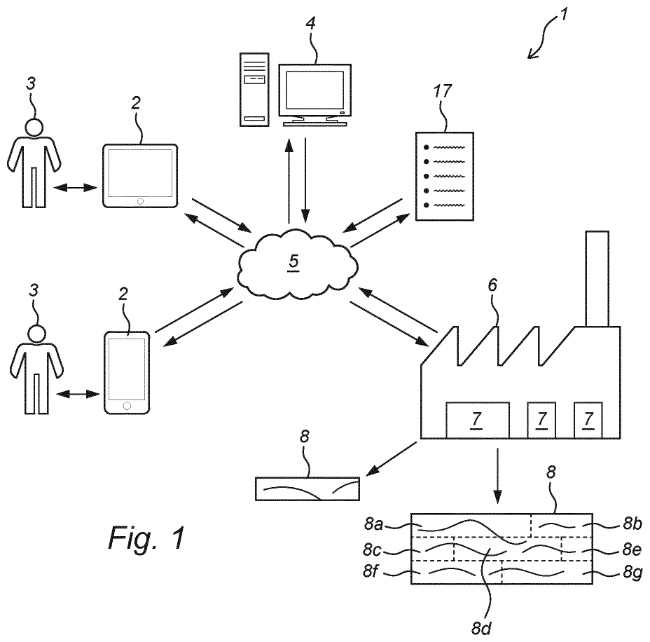

FIG. 1 shows a schematic overview of a system 1 for personalizing or customizing a floor panel 8 according to the invention. The system 1 is in particular configured for executing the method according to the invention. The method and system 1 allow a user 3 to interact via a user computing device 2 with at least one host computing device 4. The at least one user computing device 2 may for example be a mobile phone, a tablet or a personal computer of a user 3. Via said device 2 the user 3 may interact with the host computing device 4, for example via a cloud 5. Although the cloud 5 and the host computing device are in this non-limitative figure depicted separately, it is also conceivable that the host computing device 4 is in fact a part of the cloud 5 itself. The host computing device 4 is configured for, either directly, or via the cloud 5, control a production facility 6, which comprises one or more machines 7 for producing decorative laminates 8. The manufacturing facility 6 may be configured for either producing a single decorative laminate 8, or a slab 8, which may be cut into a plurality of decorative laminates 8a-8g. Preferably, each of the decorative laminates in the slab 8 is provided with opposing coupling edges, such that the separate decorative laminates 8a-8g of the slab 8 may be mutually joined. Via the described system 1 a user 3 has an increased amount of flexibility in terms of design of the decorative laminate 8. The user 3 may be prompted with a number of customizable parameters of the decorative laminate 8. For example, the decor image and the relief may be chosen by the user 3 via the at least one user computing device 2. It is conceivable that the choices made by one user 3 are, if approved, stored in a database 17 of the system 1. Said database may be used to store previously designed or customized decorative laminates from that specific user 3, for example for layer use thereof. The database may optionally be used for checking frequently chosen options, which results may be summarized and provided to the host. In terms of the embossing structure, the user may opt for an embossing which is in register with the digital layout of the decor image. It is also conceivable that the user may track the progress of the production process.

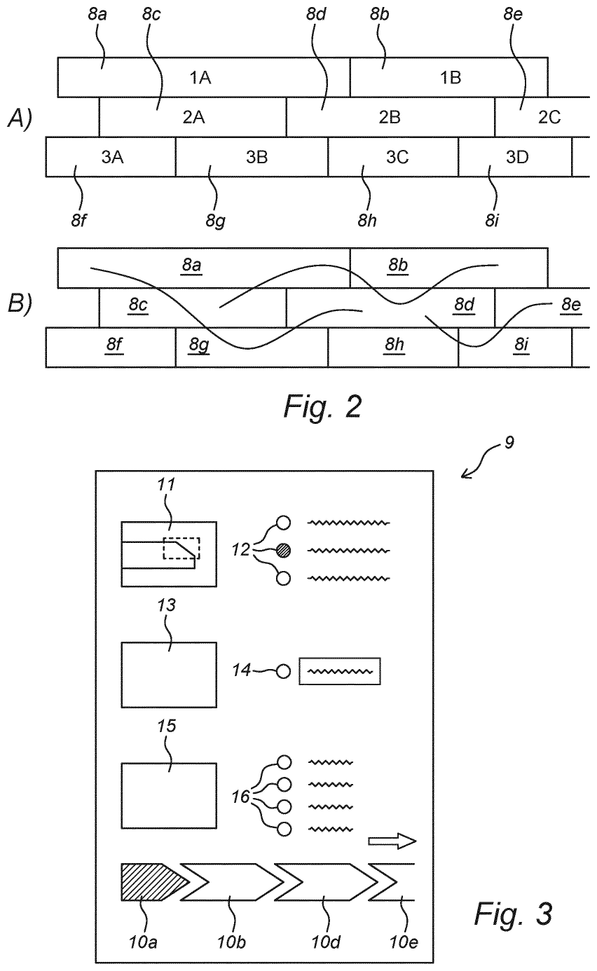

FIG. 2A and 2B respectively show a bottom side and an upper side of a floor covering composed of decorative laminates 8a-8i customized according to the present invention. As shown in FIG. 2A, the bottom sides of the decorative laminates 8a-8i are provided with a coding system which shows the order in which the decorative laminates 8a-8i are to be mutually connected. In this non-limitative embodiment each number represents a specific row, whereas the letter defines the position of the decorative laminates 8a-8i in that row. Hence, decorative laminate 8a provided with the code 1A is the first panel of the first row of decorative laminates 8a-8b. If the decorative laminates 8a-8i are placed in the right location a decor image may be realized which spans the multiple decorative laminates 8a-8i. In this instance, a wave pattern is shown, but any desired pattern or image may be chosen by the user in this respect.

FIG. 3 shows a non-limitative overview of a user interface 9 according to the invention. The user interface 9 shown in this figure may for example be loaded on a user computing device. The user interface 9 allows a user to fully customize a decorative laminate. To this end, a plurality of steps 10a-10e need to be followed by a user. Each of the steps 10a-10e allow the user to customize a part of the decorative laminate. In the presently active step, 10a, the user has three customization options 11, 13, 15. Each of the customization options 11, 13, 15 have one or more options 12, 14, 16. The first customization option 11 relates to the edges of a decorative laminate. The figure indicates a bevel, shown by the chamfer on the edge of the decorative laminate, which option is currently chosen by the user, as can be seen from the three option buttons 12. The user may have also opted for a grout, or no specific edit option. In the frame 11 of the customization option 11 the user is shown what the influence of an option will be to the end product. Optionally, it is also possible to provide the user with specific information regarding the cost of a specific option. The other customization options 13, 15 may be used for different customization options. The user may for example be able to upload a specific image, which should serve as a basis for the décor image of the decorative laminate. Moreover, the user may also define the desired embossing structure. Although in this embodiment there are only three customization options 11, 13, 15 in the first customization tab 10a, the present invention is not limited thereto. It is conceivable that the user interface 9 as shown in this figure pops up on a user computing device, or may be accessible online via a webpage.

The user may be provided with different customization options (not shown) in the other customization tabs 10b, 10c, 10d, 10e. The user may for example be allowed to choose the coding system on the bottom side of the decorative laminate, such that the user knowns in which order to install the decorative laminates. The user may also be able to choose a backing layer, and of which material said backing layer should be composed. The user may further be provided with an option to choose the thickness of the decorative laminate, and the main material or composite of the core. A further conceivable customization option would be the finish of the decorative laminate, for example an optional wear layer, or top coatings may be chosen by the user. It is also conceivable that a user may be provided with a drawing board, such that the user may draw his or her own pattern, or his or her own embossing structure.

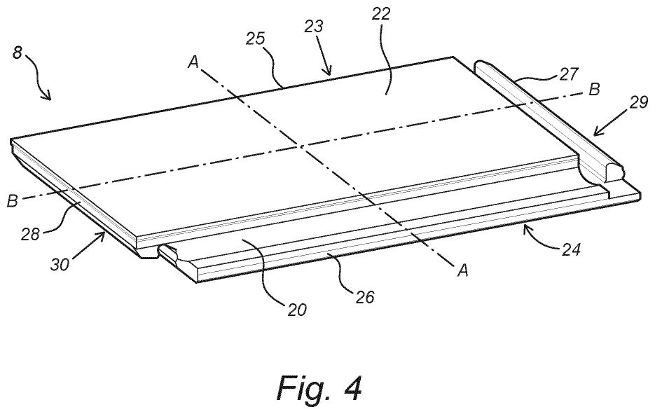

FIG. 4 shows a perspective view of an embodiment of a customized decorative laminate 8 according to the present invention, for composing a decorative surface covering, in particular a decorative floor covering. The customized decorative laminate 8 is of a rectangular shape having a length extending longitudinally along line B-B, and a width extending transversally along line A-A. The laminate 8 is provided with a substrate, which may for example be a core 20 provided with an upper side and a lower side. The panel is provided with a decorative top structure 22 affixed, either directly or indirectly, on said upper side of the core 20. The decorative top structure 22 in particular may comprise a personalized or customized decorative image digitally printed on top of said substrate 22. Preferably, a customized or personalized embossing structure is provided on top of the decorative image The sides of the decorative laminate 8 are provided with coupling profiles 25, 26, 27, 28. At opposite edges 29, 30 a first panel edge 23 comprising a first coupling profile 25, and a second panel edge 24 comprising a second coupling profile 26. The coupling profiles are designed such that the second coupling profile 6 engage interlockingly with said first coupling profile 25 of an adjacent panel, both in horizontal and in vertical direction. The decorative laminate 8 is further provided with a third coupling profile 27 and fourth coupling profile 28 at opposite edges 29 and 30 respectively, which also interlockingly engage. The user may be able to fully customize the types of coupling profiles 25, 26, 27, 28 such that they fit the need of that user. The user may also define a desired décor image, and corresponding or deviating embossing structure. This allows the user to have maximum flexibility in terms of the design freedom.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re) combined in order to arrive at a specific application. Various embodiments of the panel as described above and in the appended claims may be combined with this alternative panel configuration.

By “horizontal” is meant a direction which extends parallel to a plane defined by the floor panel, and which may intersect the core. By “vertical” is meant a direction which is perpendicular to said plane defined by the floor panel. The ordinal numbers used in this document, like “first”, “second”, and “third” are used only for identification purposes. Hence, the use of the expressions “third locking element” and “second locking element” does therefore not necessarily require the co-presence of a “first locking element”. The same applies to the numbering of method steps, wherein, for example the referral to step H) not necessarily requires that step G) should also be applied. Hence, the method steps letters are provided only for identification purposes.

By “complementary” coupling profiles is meant that these coupling profiles can cooperate with each other. However, to this end, the complementary coupling profiles do not necessarily have to have complementary forms. The “floor panel” according to the invention may also applied as wall covering element, ceiling covering element, or alternative covering element. In case in this document reference is made to a “floor tile” or “floor panel”, these expressions may be replaced by expressions like “tile”, “wall tile”, “ceiling tile”, “covering tile”.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1-34. (canceled)

35. A method for manufacturing personalized or customized decorative laminated panels, in particular decorative floor panels, for composing a decorative surface covering, in particular a decorative floor covering, comprising the steps of:
A) allowing a user to select and/or design at least one digital image relating to the decorative laminated panels to be manufactured,
B) allowing a user to select and/or design at least one digital embossing structure relating to the decorative laminated panels to be manufactured,
C) based upon the user selection made during step A) digitally printing by a printing device the at least one selected digital image onto a substrate, and
D) based upon the user selection made during step B) applying, preferably at least partially by means of digital printing by a printing device, the at least one selected embossing structure, directly or indirectly, on top of said printed digital panel image, such that the digital panel image is at least partially visible through said embossing structure, thereby forming either a laminated decorative panel or a decorative laminate to be divided into decorative laminated panels.

36. The method according to claim 35, wherein during step D) a decorative laminate is formed, and wherein the method comprises step E) comprising the step of dividing the laminate into a plurality of decorative laminated panels, preferably by means of cutting or sawing.

37. The method according to claim 36, wherein the method further comprises step F), performed after step B), which comprises the step of creating a, preferably non-staggered, digital layout of the embossing structure of the decorative laminate to be formed during step D), and wherein step E) is performed in register with the digital layout.

38. The method according to claim 35, wherein the method is a computer-implemented method, wherein step A) and step B) are performed by an end user using a digital user interface of a, preferably portable, user computing device.

39. The method according to claim 38, wherein during step A) the selected and/or designed at least one digital image is, directly or indirectly, transmitted by said user computing device to a, preferably online accessible, host computing device, wherein said host computing device is configured to, directly or indirectly, control a digital printing device for performing step C).

40. The method according to claim 38, wherein during step B) the selected and/or designed at least one digital embossing structure is, directly or indirectly, transmitted by said user computing device to a, preferably online accessible, host computing device, wherein said host computing device is configured to, directly or indirectly, control a digital printing device for performing step D).

41. The method according to claim 35, wherein during step A) the user is provided with a collection of digital panel images, in particular digital motifs, preferably via a digital user interface, wherein the user selects at least one digital image of said collection.

42. The method according to claim 35, wherein during step A) the user is allowed to select, and preferably upload, a personal digital panel image via a digital user interface.

43. The method according to claim 35, wherein during step B) the user is allowed the select the design of at least one bevel and/or grout line, preferably to be located at at least one edge of the panel, wherein the at least one bevel and/or grout line makes part of the embossing structure.

44. The method according to claim 35, wherein during step B) the user is allowed the select the relative position of at least one bevel and/or grout line with respect to the panel, wherein the at least one bevel and/or grout line makes part of the embossing structure.

45. The method according to claim 35, wherein during step B) the user is allowed the select and/or design a texture of the upper side of the decorative laminated panels to be manufactured during step D), wherein said texture makes part of the embossing structure, wherein the texture comprises indentations, such as grooves, and wherein the user is allowed to select and/or design the shape and/or depth of the indentations during step B), and/or wherein during step B) a collection of textures is provided to the user, wherein at least one texture, preferably a plurality of textures, is at least partially aligned with a digital image selected during step A).

46. The method according claim 35, wherein during step D) at least a part of the embossing structure is realized by means of mechanical processing, wherein during step D) at least a part of the embossing structure is preferably realized by means of milling or cutting away panel, and/or wherein during step D) at least a part of the embossing structure is realized by means of position-selective deforming, in particular impressing, panel material.

47. The method according to claim 35, wherein during step D) at least a part of the embossing structure is realized by multi-stage digital printing, wherein step D) comprises the sub-steps:
D1) applying a curable liquid base layer, such as a base ink layer and/or a lacquer layer, directly or indirectly, onto the printed decorative image, which preferably covers the entire printed decorative image,
D2) position-selectively applying, preferably printing, a liquid embossing ink onto the liquid base ink layer,
D3) polymerizing the base ink, and preferably the embossing ink, and
D4) preferably removing at least a part of the polymerized embossing ink, more preferably by means of mechanical processing, such as brushing.

48. The method according to claim 35, wherein the method comprises step G), performed after step D), which comprises applying a top coating on top of the embossing structure.

49. The method according to claim 35, wherein the method comprises step H), performed after steps A) and B) and prior to step C), which comprises presenting a digital preview of the decorative panel to be manufactured.

50. The method according to claim 35, wherein the method comprises step I), performed after step D), which comprises profiling at least two opposing edges of the decorative panel, such that at least one pair of opposing panel edges is provided with complementary coupling profiles allowing adjacent decorative panels to be interconnected.

51. The method according to claim 35, wherein the method comprises step J), which comprises the step of creating a user profile relating to the user, and wherein the user selection made during steps A) and B) is digitally stored within said user profile.

52. The method according to claim 35, wherein a rear side of the panel is provided with a positioning code for positioning the decorative laminated panel at the correct location for composing the decorative surface covering.

53. The method according to claim 35, wherein a rear side of the panel is provided with user details or an identification code for identifying the user and/or his delivery address.

54. The method according to claim 35, wherein the method comprises step L) comprising the step of allowing a user to select at least one other decorative laminated panel related characteristic, and wherein the method further comprises step M) comprising the step of incorporating the at least one characteristic selected during step L) into the decorative laminated panel during manufacturing of said panel.

55. A computer system, comprising at least one processor, at least one host computing device with at least one host processor, at least one user computing device with at least one user processor, and at least one computing device-readable medium having executable instructions to cause one or more of said processors to perform the method according to claim 35.

56. A non-transitory computing device-readable medium having executable instructions to cause one or more processors to perform the method according to claim 35.

57. A personalized or customized decorative laminated panel, in particular a decorative floor panel, for composing a decorative surface covering, in particular a decorative floor covering, in particular obtained by applying the method according to claim 35, comprising:
a substrate,
a personalized or customized decorative image digitally printed on top of said substrate, and
a personalized or customized embossing structure applied, and preferably digitally printed, on top of said decorative image.
